(19) United States
(12) Patent Application Publication
(10) Pub. No.: US 2012/0235014 A1
(43) Pub. Date: Sep. 20, 2012

(54) LOCKING DEVICE FOR CAMERA PLATFORM

(75) Inventor: Jie LI, Zhongshan (CN)

(73) Assignee: Zhongshan SIRUI Photographic Equipment Industry Co., Ltd., Zhongshan (CN)

(21) Appl. No.: 13/193,643

(22) Filed: Jul. 29, 2011

(30) Foreign Application Priority Data
Mar. 14, 2011 (CN) 201120065829.1

(51) Int. Cl. F16F 15/02

(52) U.S. Cl. 248/636

(57) ABSTRACT

The invention provides a camera platform locking device, comprises: a housing, for preventing the components from exiting; in said housing from the top down are configured: a sphere, for providing a support to the camera; a lower damping assembly having a inclined or spheric bottom surface, arranged underneath said sphere, for providing a damping to the upward and downward movement of said sphere; wherein, said lower damping assembly is a non-metallic elastic component in one-body form; a locking mechanism, arranged underneath said sphere, for working with said housing to lock said sphere inside the housing; an upper damping assembly is configured between the sphere and the housing for providing the damping for the upward movement of the sphere; a platform base, arranged underneath said locking mechanism, and fixedly connected to the housing, for providing a support to said locking mechanism.

### CROSS-REFERENCE TO RELATED APPLICATIONS

Pursuant to 35 U.S.C. §119 and the Paris Convention Treaty, this application claims the benefit of Chinese Patent Application No. 201120065829.1 filed on Mar. 14, 2011, the contents of which are incorporated herein by reference.

### BACKGROUND OF THE INVENTION

1. Field of the Invention

This invention relates to a photographic accessory, in particular, relates to a locking device for camera platform.

2. Description of the Related Art

A conventional locking device for camera platform has a housing, a sphere for providing a support to the camera, and a locking mechanism arranged underneath said sphere. Ordinarily, the locking mechanism is a lifting assembly which works with the housing to lock the sphere by pushing said sphere upwardly, so as to prevent it from rotating. Chinese patent publication No. CN201083949Y discloses a locking device for camera platform, from the top down comprising a sphere, a damping ring arranged underneath said sphere, and a transmission component, wherein, said transmission component has a inclined bottom, and a locking mechanism underneath said transmission component; said locking mechanism comprises a primary regulating assembly, and said primary regulating assembly further comprises a primary screw bolt, and a primary knob configured at the end of the primary screw bolt and arranged outside the housing; said primary screw bolt has two screw threads that are reverse to each other; two primary driving components having inclined surfaces are in threaded connection with corresponding screw thread on the primary screw bolt; the inclined surfaces of the two primary driving components are oppositely arranged to each other, and said primary driving components are connected to the bottom surface of the transmission component through their inclined surfaces, and drive the transmission component to move so as to push the damping ring and the sphere to move up and down through their reverse movement; wherein, the transmission component and the damping ring are separably connected together. Because of the separable connection between the damping ring and the transmission component, the balance of the damping ring during the course of movement needs to be regulated by the transmission component, and the balance of transmission component needs to be regulated by the primary driving components of the locking mechanism. As the primary driving components are connected to the transmission component through their inclined surfaces and clamp the transmission component through the opposite horizontal component force of the driving force. Therefore, it is easy to keep the balance of the transmission component, but the balance of the damping ring is difficult to be kept, due to the separable connection with the transmission component, high centre of gravity relative to that of the transmission component, and no horizontal clamping force. Consequently, the force that drives the sphere to move may not stay on the axis of the sphere, and may result in the instability of the sphere during the course of movement, poor balance of the system and poor usability of the locking device.

In addition, in the existing technology, the transmission component and the damping ring contacting the sphere are metallic components, and the primary driving components are also metallic components. As the friction force between metallic components is very large, the components in the locking device may be abraded, so as to shorten the service life of the device; furthermore, large friction force between the internal components may result in the poor usability of the device.

### SUMMARY OF THE INVENTION

In view of the above-describe problem, it is one objective of the invention to provide a locking device for camera platform with high stability and usability, which provides a damping to the movement of the sphere and facilitate the regulation to the balance of the sphere.

To achieve the above objective, in accordance with one embodiment of the invention, a locking device for camera platform comprises: a housing, for preventing the components from exiting; in said housing from the top down are configured: a sphere, for providing a support to the camera; a lower damping assembly having a inclined or spheric bottom surface, arranged underneath said sphere, for providing a damping to the upward and downward movement of said sphere; wherein, said lower damping assembly is a non-metallic elastic component in one-body form.

A locking mechanism, arranged underneath said sphere, for working with said housing to lock said sphere inside the housing, comprising a primary regulating assembly for ordinary regulation and a secondary regulating assembly for fine regulation; said primary regulating assembly comprises a primary screw bolt, and a primary knob configured at the end of the primary screw bolt and arranged outside the housing; said primary screw bolt has two screw threads that are reversely structured to each other; two primary driving components having inclined surfaces are in threaded connection with corresponding screw threads on the primary screw bolt; the inclined surfaces of the two primary driving components are oppositely arranged to each other, and said primary driving components are connected to the inclined or spheric bottom surface of the lower damping assembly through their inclined surfaces, for driving the sphere to move up and down through their reverse movement; said secondary regulating assembly for fine regulation comprises a secondary knob arranged on the primary screw bolt and on the same side as the primary knob; an upper damping assembly is configured between the sphere and the housing for providing the damping for the upward movement of the sphere, and said lower damping assembly is in movable connection with the internal wall of the housing; said primary regulating assembly also comprises a primary fixing assembly, connected to the housing, for preventing the primary screw bolt from exiting; a platform base, arranged underneath said locking mechanism, and fixedly connected to the housing, for providing a support to said locking mechanism; wherein, said platform base from the top down comprises a shim arranged underneath said locking mechanism and connected to it; a snap spring, arranged in the slot on the internal wall of the housing; a platform base supporting assembly, arranged underneath the snap spring and connected to it, so as to provide a support to said platform; a platform base locking mechanism connected to said platform supporting assembly, for locking said platform base.

The locking device for camera platform wherein, the non-metallic elastic component is a plastic member, or a wooden member, or a block rubber.

This invention has the advantages as below:

1. In said housing from the top down are configured: a sphere, for providing a support to the camera; a lower damping assembly, arranged underneath said sphere, for providing a damping to the upward and downward movement of said sphere a locking mechanism, arranged underneath said sphere, for working with said housing to lock said sphere inside the housing; a platform base, arranged underneath said locking mechanism, and fixedly connected to the housing, for providing a support to said locking mechanism; wherein, said lower damping assembly is a non-metallic elastic component in one-body form. The above design not only provides a damping to the movement of said sphere, but also lowers the centre of gravity which is also the point for balance, to facilitate the regulation of balance of the lower damping component, to further facilitate the regulation of the sphere, thereby improving the stability and usability of the device.

2. That said non-metallic elastic component is a plastic member, a wooden member, or a block rubber not only enables the device to have damping, and facilitates the regulation of balance of sphere, so as to improve the stability and usability of device; but also protects the components configured internally, such as sphere, locking mechanism (including primary driving components and secondary driving components) from being abraded, so as to enhance the service life of device; further more, the usability of device is improved due to the fact that the friction between the sphere and the lower damping component and the friction between the lower damping component and the locking mechanism are reduced.

3. Said lower damping assembly has a spheric or inclined bottom; said locking mechanism, comprises a primary regulating assembly and a secondary regulating assembly, said primary regulating assembly comprises a primary screw bolt, and a primary knob configured at the end of the primary screw bolt and arranged outside the housing; said primary screw bolt has two screw threads that are reverse to each other; two primary driving components having inclined surfaces are in threaded connection with corresponding screw threads on the primary screw bolt; the inclined surfaces of the two primary driving components are oppositely arranged to each other, and said primary driving components are connected to the bottom surface of the lower damping assembly through their inclined surfaces, for driving the sphere to move up and down through their reverse movement. The above design can not only drive the sphere to move upward, but also make sure an appropriate height of the locking mechanism, so as to make sure there is no big room occupied in the device.

4. An upper damping assembly is configured between the sphere and the housing for providing the damping for the upward movement of the sphere, and said lower damping assembly is in movable connection with the internal wall of the housing. The above design can make sure the sphere will not sway during the course of upward and downward movement along the axis of the device.

5. Said primary regulating assembly comprises a primary fixing assembly, connected to the housing, which can prevent the primary screw bolt from exiting.

### BRIEF DESCRIPTION OF THE DRAWINGS

Reference characters of accompanying drawing are provided below:

1—housing, 2—upper damping assembly, 3—sphere, 4—lower damping assembly, 5—platform base locking assembly, 6—primary screw bolt, 7 and 8—primary driving component, 9—shim, 10—supporting ring, 11—screw nut, 12—primary knob, 13—secondary knob, 17—primary fixing assembly, 18—platform base, 19—screw fixing component.

### DETAILED DESCRIPTION OF THE EMBODIMENTS

Detailed description will be given below in conjunction with accompanying drawing.

### Example 1

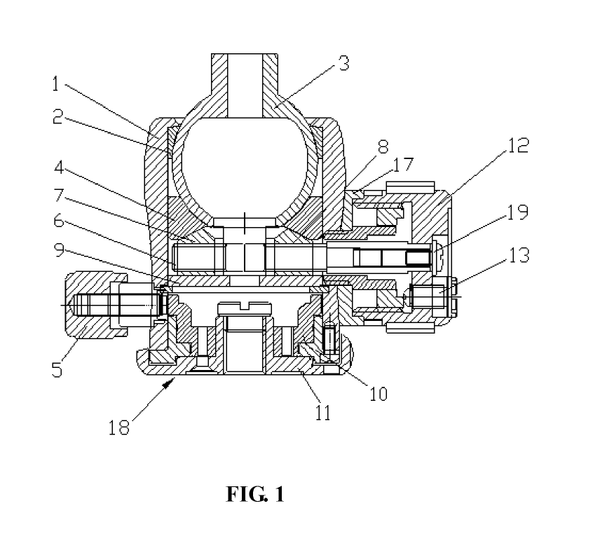

As shown in FIG. 1, the locking device for the camera platform, comprises: a housing 1, for preventing the components from exiting; in the housing 1 from the top down are configured: a sphere 3, for providing a support to the camera; and a lower damping assembly 4, having a inclined or spheric bottom surface, arranged underneath the sphere, for providing a damping to the upward and downward movement of the sphere 3; wherein, the lower damping assembly is a non-metallic elastic component in one-body form; a locking mechanism, arranged underneath the sphere 3, for working with the housing 1 to lock the sphere 3 inside the housing 1; wherein, the locking mechanism comprises a primary regulating assembly for ordinary regulation and a secondary regulating assembly for fine regulation. The primary regulating assembly comprises a primary screw bolt 6, and a primary knob 12 configured at the end of the primary screw bolt 6 and arranged outside the housing 1; the primary screw bolt 6 has two screw threads that are reversely structured to each other; two primary driving components 7 and 8 having inclined surfaces are in threaded connection with corresponding screw thread on the primary screw bolt 6; and the inclined surfaces of the two primary driving components 7 and 8 are oppositely arranged to each other, and the primary driving components 7 and 8 are connected to the inclined or spheric bottom surface of the lower damping assembly through their inclined surfaces, for driving the sphere 3 to move up and down through their reverse movement. The primary regulating assembly further comprises a primary fixing assembly 17, connected to the housing, for preventing the primary screw bolt 6 from exiting, and a screw fixing component 19, for preventing the primary knob 6 from separating from the primary screw bolt 6. The secondary regulating assembly for fine regulation comprises a secondary knob 13 arranged on the primary screw bolt 6 and located on the same side as the primary knob, wherein, the secondary knob 13 is also arranged outside the housing 1. The secondary knob is rotated to drive the primary driving components 7 and 8 to move reversely through the primary screw bolt 6. The sphere 3 is further driven to move up and down by the primary driving components 7 and 8 through their reverse movement.

The device further comprises an upper damping assembly 2 configured between the sphere 3 and the housing 3 for providing a damping to the upward movement of the sphere 3, wherein the external diameter of the lower damping assembly 4 is equal to the internal diameter of the housing 1, and the lower damping assembly 4 is in movable connection with the internal wall of the housing 1.

In addition, a damping ring for fine regulation is arranged at the end of the secondary knob 13, close to the housing, wherein, the damping ring for fine regulation is integrally cast to the secondary knob 13 in one body form.

A platform base 18, is arranged underneath the locking mechanism, and fixedly connected to the housing 1, for providing a support to the locking mechanism. The platform base 18 from the top down comprises a snap spring (not illustrated), arranged in the slot on the internal wall of the housing; a platform base supporting assembly, arranged underneath the snap spring and connected to it, for providing a support to the platform, in this example the platform base supporting assembly is a supporting ring 10; and a platform base locking assembly 5 connected to the platform supporting mechanism, for locking the platform base, the platform base locking mechanism is a screw nut 11 in this example.

In this example, the non-metallic elastic component can be a plastic member, a wooden member, or a block rubber.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A locking device for camera platform, comprises: a housing, for preventing the components from exiting; in said housing from the top down are configured: a sphere, for providing a support to the camera; a lower damping assembly having a inclined or spheric bottom surface, arranged underneath said sphere, for providing a damping to the upward and downward movement of said sphere; wherein, said lower damping assembly is a non-metallic elastic component in one-body form; a locking mechanism, arranged underneath said sphere, for working with said housing to lock said sphere inside the housing, comprising a primary regulating assembly for ordinary regulation and a secondary regulating assembly for fine regulation; said primary regulating assembly comprises a primary screw bolt, and a primary knob configured at the end of the primary screw bolt and arranged outside the housing; said primary screw bolt has two screw threads that are reversely structured to each other; two primary driving components having inclined surfaces are in threaded connection with corresponding screw threads on the primary screw bolt; the inclined surfaces of the two primary driving components are oppositely arranged to each other, and said primary driving components are connected to the inclined or spheric bottom surface of the lower damping assembly through their inclined surfaces, for driving the sphere to move up and down through their reverse movement; said secondary regulating assembly for fine regulation comprises a secondary knob arranged on the primary screw bolt and on the same side as the primary knob; an upper damping assembly is configured between the sphere and the housing for providing the damping for the upward movement of the sphere, and said lower damping assembly is in movable connection with the internal wall of the housing; said primary regulating assembly also comprises a primary fixing assembly, connected to the housing, for preventing the primary screw bolt from exiting; a platform base, arranged underneath said locking mechanism, and fixedly connected to the housing, for providing a support to said locking mechanism; wherein, said platform base from the top down comprises a shim arranged underneath said locking mechanism and connected to it; a snap spring, arranged in the slot on the internal wall of the housing; a platform base supporting assembly, arranged underneath the snap spring and connected to it, so as to provide a support to said platform; a platform base locking mechanism connected to said platform supporting assembly, for locking said platform base.

2. The locking device for camera platform of claim 1, wherein, said non-metallic elastic component is a plastic member, a wooden member, or a block rubber.
